(19) United States
(12) Patent Application Publication
(10) Pub. No.: US 2024/0409834 A1
(43) Pub. Date: Dec. 12, 2024

(54) HIGHLY EFFICIENT METHANE SEPARATION FOR RNG-LNG AND CO2 CONVERSION

(71) Applicant: GAS TECHNOLOGIES LLC, Walloon Lake, MI (US)

(72) Inventors: Walter BREIDENSTEIN, Boyne Falls, MI (US); Evan VISSER, Spring, TX (US); Hanif CHOUDHURY, Walloon Lake, MI (US)

(73) Assignee: GAS TECHNOLOGIES LLC, Walloon Lake, MI (US)

(21) Appl. No.: 18/700,882

(22) PCT Filed: Oct. 12, 2022
(86) PCT No.: PCT/US2022/046429

§ 371 Date: Apr. 12, 2024

Related U.S. Application Data
(60) Provisional application No. 63/254,905, filed on Oct. 12, 2021.

(51) Int. Cl. C10L 3/10

(52) U.S. Cl. CPC C10L 3/106; C10L 3/103; C10L 3/104; C10L 2290/08; C10L 2290/542; C10L 2290/547

(57) ABSTRACT

A methane purification system includes one or more components that cool and compress an input methane-containing gaseous mixture stream to form a first methane-containing gaseous mixture stream. A filter-separator in fluid communication with the one or more components receives the first methane-containing gaseous mixture stream removing water therefrom to form a second methane-containing gaseous mixture stream. An activated carbon station receives the second methane-containing gaseous mixture stream removing hydrogen sulfide therefrom to form a third methane-containing gaseous mixture stream. A methanol scrubber that receives the third methane-containing gaseous mixture stream or an expanded stream therefrom, removing carbon dioxide to form a fourth methane-containing gaseous mixture stream. A final stage separator produces a purified methane stream from the fourth methane-containing gaseous mixture stream or an expanded stream therefrom.

### CROSS-REFERENCE TO RELATED APPLICATIONS

This application claims the benefit of U.S. provisional application Ser. No. 63/254,905 filed Oct. 12, 2021, the disclosure of which is hereby incorporated in its entirety by reference herein.

### TECHNICAL FIELD

In at least one aspect, a system for providing purified methane from a methane-containing gaseous mixture is provided.

### BACKGROUND

Methane is an important clean burning fuel that is increasingly becoming more desirable. Natural methane-containing sources typically provide methane in an impure state. Such natural methane sources include swamps, agricultural food waste, municipal waste, plant material, or sewage.

Accordingly, there is a need for purifying methane obtained from natural sources.

### SUMMARY

In at least one aspect, a methane purification system is provided. The methane purification system includes one or more components that cool and compress an input methane-containing gaseous mixture stream to form a first methane-containing gaseous mixture stream. A filter-separator in fluid communication with the one or more components receives the first methane-containing gaseous mixture stream removing water therefrom to form a second methane-containing gaseous mixture stream. An activated carbon station receives the second methane-containing gaseous mixture stream removing hydrogen sulfide therefrom to form a third methane-containing gaseous mixture stream. A methanol scrubber receives the third methane-containing gaseous mixture stream or an expanded stream therefrom, removing carbon dioxide to form a fourth methane-containing gaseous mixture stream. A final stage separator produces a purified methane stream from the fourth methane-containing gaseous mixture stream or an expanded stream therefrom.

In another aspect, the methane purification system further includes a dielectric barrier discharge reactor configured to produce higher alcohols (e.g., greater than or equal to C₂ such as ethanol) from CO₂ with higher selectivity than lower alcohols (i.e., methanol).

In another aspect, the carbon dioxide removed from the methane-containing gas mixture is utilized in a catalytic reaction for conversion to alcohol comprising carbon number C₁, C₂, or above (i.e. alcohols with 1, 2, or more carbon atoms). The alcohol mixture may contain either C₁ or C₂ or a mixture of C₁ and C₂. The catalytic conversion reaction may either use a conventional thermochemical reactor configuration or use a non-conventional radio frequency reactor configuration. The radio frequency configuration may comprise a dielectric barrier discharge (DBD) plasma reactor packed with a catalyst that includes transition metals and metal oxides. The catalyst may include either supported or un-supported, doped, mono-metallic, bimetallic, or mixed metal oxide. The DBD reactor can be operated at temperatures of 80-200° C., 0-100 psia pressure and gas flow rates between 10-1000 mL/min for a 5-100 mg catalyst bed. The reactor can be made of simple quartz tube, inert materials such as metal oxides or ceramics for industrial application. The reactor configuration can be either fixed bed or fluidized bed. A fixed bed rector may be either single tube or multi-tubular reactor configuration.

In another aspect, the final stage separator is an LNG separator.

In another aspect, the final stage separator is a PSA/membrane system.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1A. Schematic of a methane purification system having an LNG separator.

FIG. 1B. Schematic of an ethanol production system using a DBD reactor configuration.

FIG. 2. Schematic of a methane purification system having an PSA/membrane system.

FIG. 3. Multi-tubular plasma reactor for converting carbon dioxide to alcohols.

FIG. 4A. Longitudinal cross-section of a dielectric barrier discharge plasma reactor.

FIG. 4B. Cross-section of a dielectric barrier discharge plasma reactor perpendicular to the cross-section of FIG. 4A.

FIG. 5A. Longitudinal cross-section of a dielectric barrier discharge plasma reactor.

FIG. 5B. Cross-section of a dielectric barrier discharge plasma reactor perpendicular to the cross-section of FIG. 5A.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of.” and ratio values are by weight; the term “polymer” includes “oligomer,” “copolymer,” “terpolymer.” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It must also be noted that, as used in the specification and the appended claims, the singular form “a.” “an,” and “the” comprise plural referents unless the context clearly indicates otherwise. For example, reference to a component in the singular is intended to comprise a plurality of components.

As used herein, the term “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the invention can be obtained within a range of +/−5% of the indicated value.

As used herein, the term “and/or” means that either all or only one of the elements of said group may be present. For example. “A and/or B” shall mean “only A. or only B. or both A and B”. In the case of “only A”, the term also covers the possibility that B is absent, i.e. “only A, but not B”.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The phrase “composed of” means “including” or “consisting of.” Typically, this phrase is used to denote that an object is formed from a material.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” and “multiple” as a subset. In a refinement, “one or more” includes “two or more.”

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within +0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numeral quantity, in a refinement, the term “less than” includes a lower non-included limit that is 5 percent of the number indicated after “less than.” For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, or 1 percent of the number indicated after “less than.”

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

For all compounds expressed as an empirical chemical formula with a plurality of letters and numeric subscripts (e.g., CH₂O), values of the subscripts can be plus or minus 50 percent of the values indicated rounded to or truncated to two significant figures. For example, if CH₂O is indicated, a compound of formula C_{(0.8-1.2)}H_{(1.6-2.4)}O_{(0.8-1.2)}. In a refinement, values of the subscripts can be plus or minus 30 percent of the values indicated rounded to or truncated to two significant figures. In still another refinement, values of the subscripts can be plus or minus 20 percent of the values indicated rounded to or truncated to two significant figures.

### Abbreviations

“LNG” means liquified natural gas.
“PSA” means pressure swing absorption.
“RNG” means renewable natural gas.
“DBD” dielectric barrier discharge

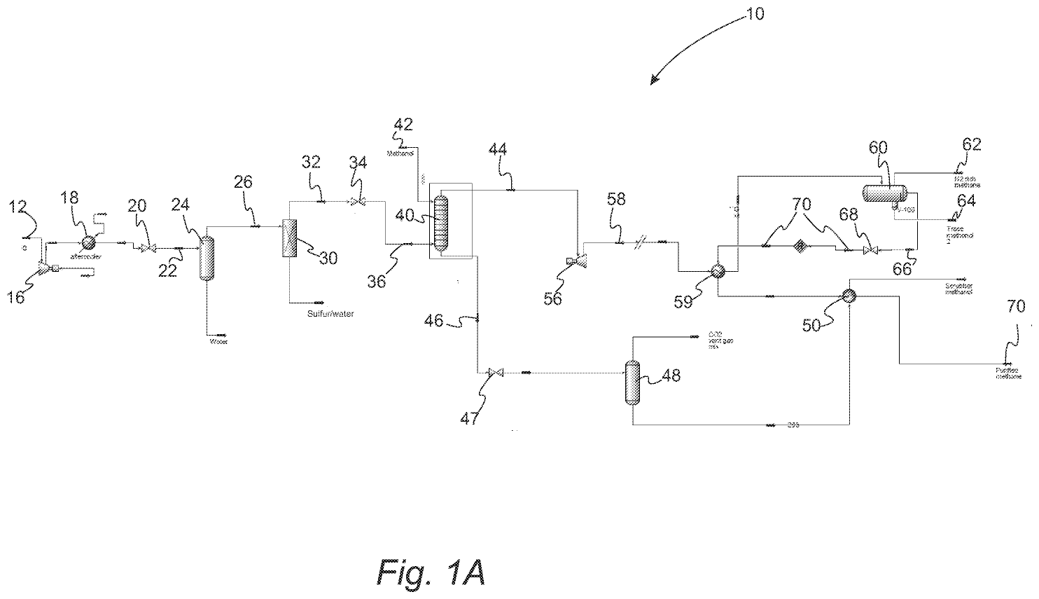

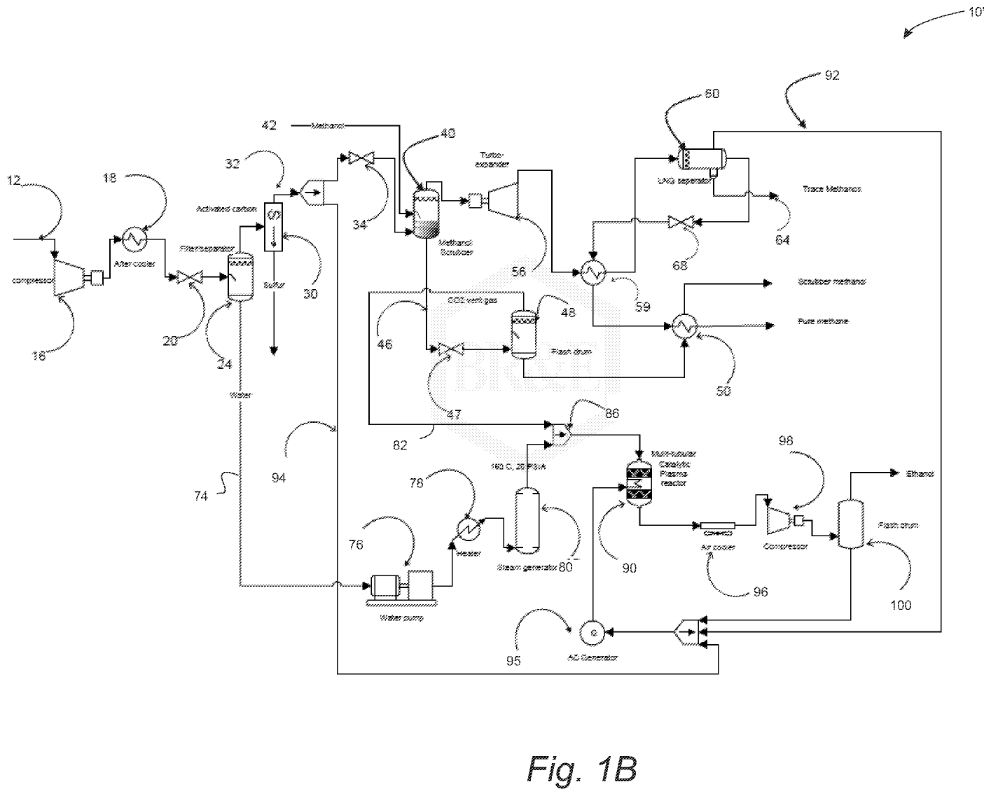

FIG. 1A provides a schematic of a system for purifying biogas to obtain purified natural gas (e.g., methane). Purification system 10 receives as input a methane-containing gaseous mixture stream 12. Typically, the methane-containing gaseous mixture stream 12 includes methane and one or more of carbon dioxide, nitrogen, oxygen, water, hydrogen sulfide, and methanol. In a refinement, the methane-containing gaseous mixture stream 12 includes methane and any combination of carbon dioxide, nitrogen, oxygen, water, hydrogen sulfide, and methanol. In a refinement, the methane-containing gaseous mixture includes methane, carbon dioxide, nitrogen, oxygen, water, hydrogen sulfide, and methanol. In a refinement, the methane-containing gaseous mixture stream 12 is derived from a biogas which can be produced from raw materials such as agricultural food waste, waste, municipal waste, plant material, or sewage. In a refinement, methane-containing gaseous mixture stream 12 includes greater than 40 mole percent methane. In a further refinement, methane-containing gaseous mixture stream 12 includes greater than 50 mole percent methane. In some refinements, methane-containing gaseous mixture stream 12 includes methane in an amount greater than or equal to 10, 20, 30 40, 60, 70, or 80 mole percent methane. In further refinements, methane-containing gaseous mixture stream 12 includes methane in an amount less than or equal to 100, 99, 95, 90, 80, 70, or 60 mole percent methane. Typically, methane-containing gaseous mixture stream 12 includes significant amounts of carbon dioxide (e.g., 30 to 60 mole percent). In a variation, methane-containing gaseous mixture stream 12 is provided at a temperature from about 50° F. to about 120° F. and at a pressure from about 0.1 psai to about 1.2 psia.

The methane-containing gaseous mixture stream 12 is cooled by one or more components to a temperature that is greater than 32° F. and less than 100° F. before flowing into a filter-separator. For example, this cooling can proceed by the methane-containing gaseous mixture 12 first being compressed by compressor 16 and then direct through aftercooler 18 (e.g., a heat exchanger). The partially cooled stream then flows through expansion valve 20 to form methane-containing gaseous mixture stream 22. Methane-containing gaseous mixture stream 22 is at a temperature that is from about 50° F. to about 80° F. and a pressure from about 1400 to 2000 psia.

Methane-containing gaseous mixture stream 22 then flows into filter separator 24 from which liquid water is removed. Filter separator 24 can include a column and in particular, a packed column. The packing in the column provides a high surface area to allow efficient condensation of water. Methane-containing gaseous mixture stream 26 emerging from separator 24 is therefore depleted of free water. Methane-containing gaseous mixture stream 26 then flows through activated carbon station 30 in which hydrogen sulfide and additional water are removed,

Methane-containing gaseous mixture stream 32 emerges from activated carbon station 30 and then flows through expansion valve 34 which drops the temperature and pressure to form methane-containing gaseous mixture stream 36. In a refinement, methane-containing gaseous mixture stream 36 is at a temperature from about 3 to 15° F. and a pressure of about 500 to 1000 psai. Methane-containing gaseous mixture stream 36 flows to methanol scrubber 40 which also receives a stream of liquid methanol 42. The liquid methanol stream can be a varying mixture of methanol in water. In a refinement, stream of liquid methanol 42 includes 30% methanol in water to 100% methanol. Stream of liquid methanol 42 can be at a temperature from about −60° F. to about −30° F. and a pressure of about 1000 to 1600 psai. Methanol scrubber 40 removes carbon dioxide to form methane-containing gaseous mixture stream 44 and carbon dioxide and methanol stream 46. The removed carbon dioxide can be converted to alcohols (e.g., ethanol) as set forth below. In a refinement, methane-containing gaseous mixture stream 44 is at a temperature from about −70° F. to −10° F. and a pressure from about 400 to 800 psia. Carbon dioxide and methanol stream 46 flows through expansion value 47 and then to flash drum 48 from which carbon dioxide stream 50 is vented and liquid methanol recovered and direct back to methanol scrubber 40 optionally passing through heat exchanger 50. Carbon dioxide stream 50 can be converted to alcohols (e.g., ethanol) as set forth below.

Methane-containing gaseous mixture stream 44 emerging from methanol scrubber is enriched in methane. In a refinement, methane-containing gaseous mixture stream 44 includes greater than 80 mole percent methane. However, methane-containing gaseous mixture stream 44 can also include a small amount of molecular nitrogen gas, typically in an amount from about 2 to 18 mole percent.

Methane-containing gaseous mixture stream 44 then flows through turbo-expander 56 which further drop the temperature and pressure to form methane-containing gaseous mixture stream 58. In a refinement, methane-containing gaseous mixture stream 58 is at a temperature from about-180° F. to −120° F. and at a pressure from about 100 to 200 psia.

Methane-containing gaseous mixture stream 58 flows through heat exchanger 59 and then into LNG separator 60 which separates methane-containing gaseous mixture stream 58 into N₂ rich stream 62, trace methanol stream 64, and purified methane stream 66 which is expanded in valve 68 and then collected as an output purified methane stream 70. In a refinement, LNG separator 60 can operated at a temperature from about −250° F. to 150° F. and a pressure from about 100 to 200 psia. Similarly, N₂ rich stream 62 and purified methane stream 66 can be at a temperature from about −270° F. to −170° F. and a pressure from about 70 to 100 psia.

Purified methane stream 66 flows through expansion valve 68 to form purified methane stream 70 which can be at a temperature from about −250° F. to 150° F. and a pressure from about 100 to 200 psia. Purified methane stream 70 flow throw heat exchange 59 which increases the temperature and then through heat exchanger 50 which further increases the temperature (e.g., form about-80 to 0° F.)

Referring to FIG. 1B, a variation of the systems of FIG. 1A having a plasma reactor configuration for co-production of ethanol from the biogas purification methane plant. System 10′ includes the same components for removing CO₂ set forth above. The saturated water 74 collected from the vessel of separator 24 is pumped via pump 76 through heater 78 to a steam generator 80. The steam can be generated by electrical heater boiling the water. The steam is then mixed with the CO₂ gas 82 which is removed from the biogas by the methanol scrubber and comes off the flash drum 48. The two gases, CO₂ and steam are mixed in a desired molar ratio in the mixer 86 before entering the plasma reactor 90. In another configuration, the CO₂ gas can be bubbled through a hot water vessel prior to entering the plasma reactor. The heater can be power by an alternating current (AC) generator producing electricity at the plant site utilizing the low BTU vent gas source such as stream 92. The generator may be energized at the start-up utilizing clean biogas slip steam 94. The same AC generator 95 can also power the plasma rector for CO₂ conversion reaction. The downstream gas of the plasma reactor can be cooled by an air fin cooler 96 followed by a compressor 98. A flash separation column 100 either packed bed or unpacked can be used to separate the ethanol form the gas mixture. The unconverted gas mixtures can be used to power the AC generator 95.

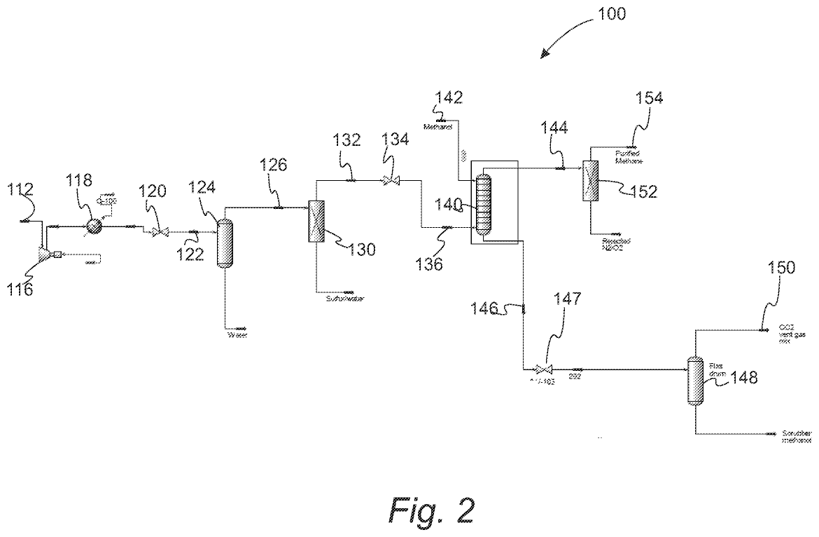

FIG. 2 provides a schematic of a system for purifying biogas to obtain purified natural gas (e.g., methane). System 110 receives as input includes methane-containing gaseous mixture stream 112. Typically, the methane-containing gaseous mixture stream 112 includes methane and one or more of carbon dioxide, nitrogen, oxygen, water, hydrogen sulfide, and methanol. In a refinement, the methane-containing gaseous mixture includes methane, carbon dioxide, nitrogen, oxygen, water, hydrogen sulfide, and methanol. In a refinement, the methane-containing gaseous mixture stream 112 includes a biogas which can be produced from raw materials such as agricultural food waste, waste, municipal waste, plant material, or sewage. In a refinement, methane-containing gaseous mixture stream 112 includes greater than 40 mole percent methane. In a further refinement, methane-containing gaseous mixture stream 112 includes greater than 50 mole percent methane. Typically, methane-containing gaseous mixture stream 112 includes significant amounts of carbon dioxide (e.g., 30 to 60 mole percent). In a variation, methane-containing gaseous mixture stream 112 is provided at a temperature from about 50° F. to about 120° F. and at a pressure from about 0.1 psai to about 1.2 psia.

In a refinement, methane-containing gaseous mixture stream 112 is cooled by one or more components before flowing into a filter-separator. For example, this cooling can proceed by the methane-containing gaseous mixture 112 first being compressed by compressor 116 and then direct through aftercooler 118 (e.g., a heat exchanger). The partially cooled stream then flows through expansion valve 120 to form a methane-containing gaseous mixture stream 212. Methane-containing gaseous mixture stream 122 is at a temperature that is from about 50° F. to about 80° F. and a pressure from about 1400 to 2000 psia.

Methane-containing gaseous mixture stream 122 then flows into filter separator 124 from which liquid water is removed. Filter separator 124 can include a column and in particular, a packed column. The packing in the column provides a surface area to allow efficient condensation of water. Methane-containing gaseous mixture stream 126 emerging from separator 124 is therefore depleted of free water. Methane-containing gaseous mixture stream 126 then flows through activated carbon station 130 in which hydrogen sulfide and additional water are removed.

Methane-containing gaseous mixture stream 132 emerges from activated carbon station 130 and then flows through expansion valve 134 which drops the temperature and pressure to form methane-containing gaseous mixture stream 136. In a refinement, methane-containing gaseous mixture stream 136 is at a temperature from about 3 to 15° F. and a pressure of about 500 to 1000 psai. Methane-containing gaseous mixture stream 136 flows to methanol scrubber 140 which also receives a stream of liquid methanol 142. The liquid methanol stream can be a varying mixture of methanol in water. In a refinement, stream of liquid methanol 42 includes 30% methanol in water to 100% methanol. Stream of liquid methanol 142 can be at a temperature from about −60° F. to about −30° F. and a pressure of about 1000 to 1600 psai. Methanol scrubber 140 removes carbon dioxide to form methane-containing gaseous mixture stream 144 and carbon dioxide and methanol stream 146. In a refinement, methane-containing gaseous mixture stream 144 is at a temperature from about −70° F. to −10° F. and a pressure from about 400 to 800 psai. Carbon dioxide and methanol stream 146 flows through expansion value 147 and then to flash drum 148 from which carbon dioxide stream 150 is vented and liquid methanol recovered and direct back to methanol scrubber 140 optionally passing through a heat exchanger. The carbon dioxide stream 150 can be converted to alcohols (e.g., ethanol) as set forth below.

Methane-containing gaseous mixture stream 144 emerging from methanol scrubber 140 is enriched in methane. In a refinement, methane-containing gaseous mixture stream 144 includes greater than 80 mole percent methane. In some refinements, methane-containing gaseous mixture stream 144 includes methane in an amount greater than or equal to 70, 75, 80, 85, or 90 mole percent methane. In further refinements, methane-containing gaseous mixture stream 144 includes methane in an amount less than or equal to 100, 99. 95, 90, or 85 mole percent methane. However, methane-containing gaseous mixture stream 144 can also include a small amount of molecular nitrogen gas, typically in an amount from about 2 to 18 mole percent.

Methane-containing gaseous mixture stream 144 then flows through PSA membrane system 152 which allows purified methane stream 154 to be formed. In a refinement, methane-containing gaseous mixture stream 144 is at a temperature from about −180° F. to −120° F. and at a pressure from about 100 to 200 psia. Purified methane stream 154 can be at a temperature from about −70° F. to −20° F. and a pressure from about 400 to 800 psia.

The PSA system 152 can be either made of adsorbents or membranes. The adsorbent in the PSA system can be either activated carbon, carbon molecular sieve, zeolite, or mixture of them while the membrane system can comprise of either cellulose acetate (CA) membranes, polymeric membranes such as silicones, polysulfones, polycarbonates, polyamides, polyimides or graphene oxide membrane. The PSA adsorber can be either a single bed or multibed configuration. The PSA system 152 can be used when the feed stream includes methan molar concentration greater than or equal to 80 mole %.

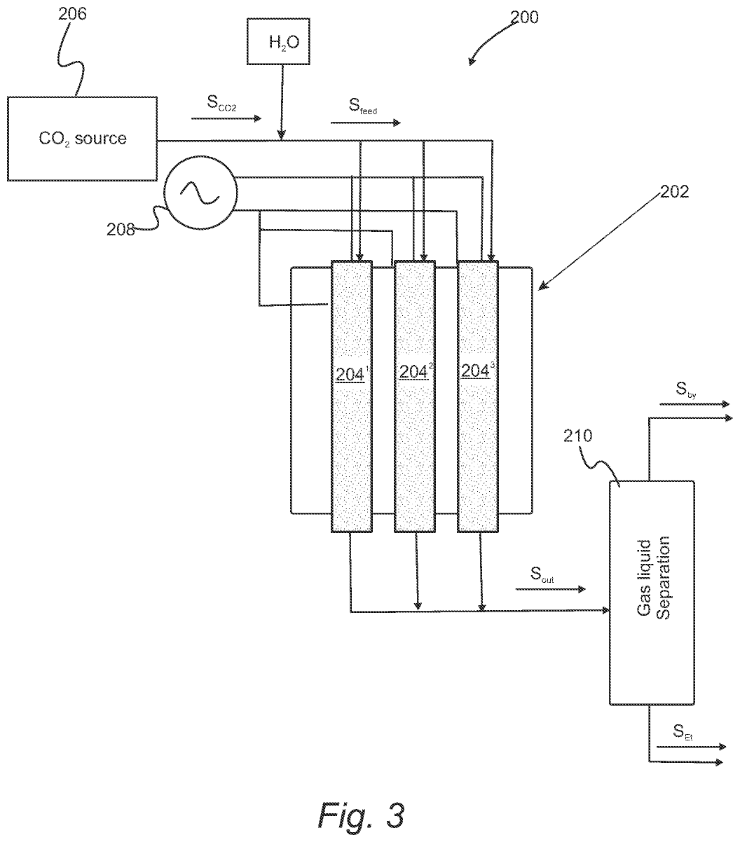

Referring to FIG. 3, a schematic of a multi-tubular plasma reactor system that can convert the carbon dioxide waste from the systems of FIGS. 1A, 1B, and 2 is provided. Details of plasma reactor systems are found in U.S. patent application Ser. No. 17/725,137 filed Apr. 20, 2022; the entire disclosure of which is hereby incorporated by reference. Plasma reactor system 200 includes CO₂ conversion system 202 which includes a plurality of dielectric barrier discharge plasma reactors 204 where i is an integer label for each reactor. Although virtually any number of dielectric barrier discharge plasma reactors can be used, typically CO₂ conversion subsystem 202 includes 1 to 50 dielectric barrier discharge plasma reactors 204ⁱ. FIG. 3 depicts an example with 3 dielectric barrier discharge plasma reactors (i.e., i=3). A CO₂-containing gas feed stream S_{feed} is provided to CO₂ conversion subsystem 202. CO₂-containing gas feed stream S_{feed} includes CO₂-containing gas stream S_{CO2} from a CO2 source 206. If the water content of CO₂-containing gas stream S_{CO2} is insufficient, water is added to CO₂-containing gas stream S_{CO2} to form CO₂-containing gas feed stream S_{feed}. If the water content of CO₂-containing gas stream S_{CO2} is sufficient, CO₂-containing gas stream S_{CO2} can operate as the CO₂-containing gas feed stream S_{feed}. The CO₂ source 206 can be virtually any source of CO₂ including industrial reactors and naturally occurring sources of CO₂. In a refinement, the CO₂-containing source is an industrial reactor produced methanol, ethanol, or combinations thereof.

The plurality of dielectric barrier discharge plasma reactors 204 converts the CO₂-containing gas stream S_{CO2} into an output alcohol-containing stream (e.g., ethanol-containing stream S_{Et}). Power supply 208 is used to power the electrodes contained in the dielectric barrier discharge plasma reactors 204ⁱ. The outputs from all of the dielectric barrier discharge plasma reactors 204ⁱ.are pooled to form output ethanol-containing stream Sₒᵤₜ. Gas-liquid separator 210 is used to separate ethanol as stream SE from other reaction byproducts and impurities as stream S_{by}. In a refinement, the systems of FIGS. 1A, 1B, and 2 can be integrated with a plasma reactor system 200 for highly economical and efficient production of high purity ethanol.

A plasma in reactors can be thermally and/or non-thermally generated. Sources of power can be from both non-renewable or renewable sources such as methane, associated gases, nitrogen, carbon dioxide, wind, solar, hydro, nuclear or a combination thereof.

In another aspect, the dielectric barrier discharge reactor is configured to produce ethanol from CO₂. In a refinement, the dielectric barrier discharge reactor utilizes a mixed metal oxide catalyst to produce alcohol with a higher selectivity towards ethanol than other alcohols. In a further refinement, the higher selectivity towards ethanol varies form 50-100% depending on the input methane-containing gaseous mixture stream and catalyst recipe.

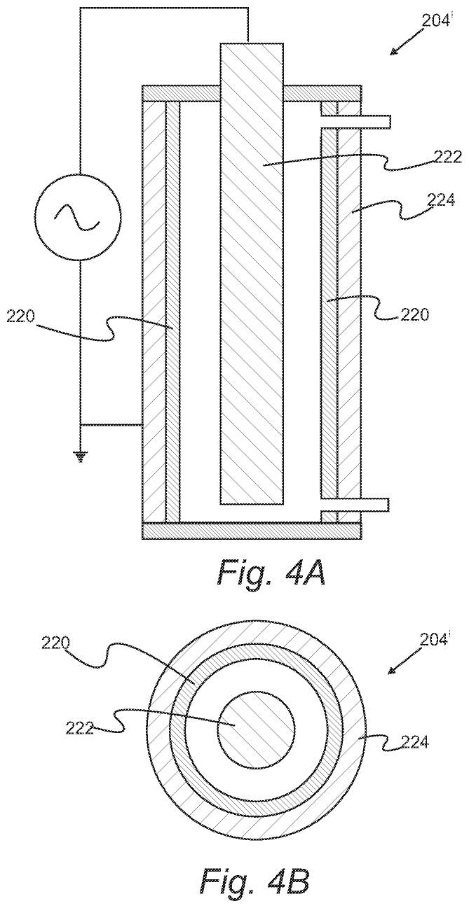

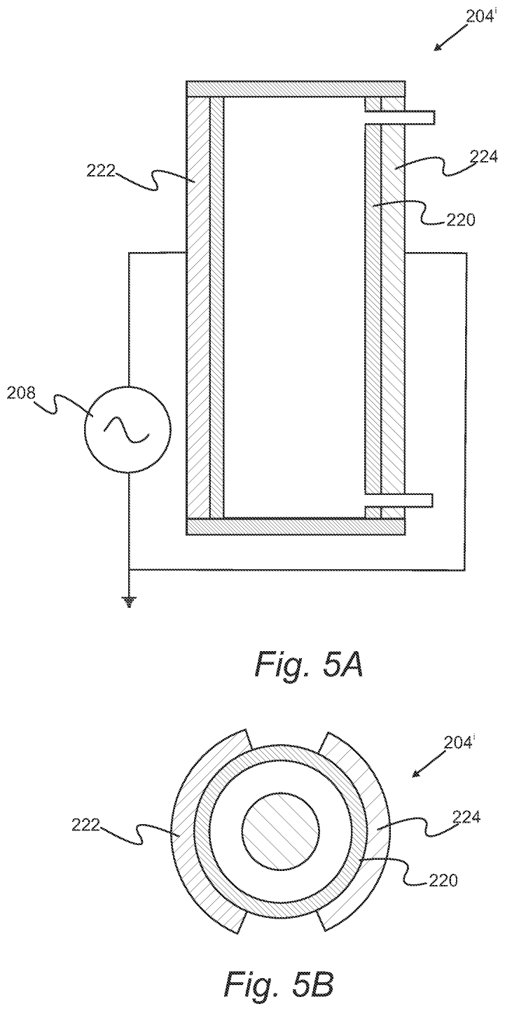

In some variations, a dielectric barrier discharge plasma reactor includes a reaction tube (e.g., a quartz tube) and a pair of electrodes which are activated with an AC voltage to form an RF plasma that converts CO₂ to ethanol. FIGS. 4A, 4B, 5A, and 5B provide schematics of a design for a dielectric barrier discharge plasma reactor. Dielectric barrier discharge plasma reactors 204 includes a reaction tube 220 which is composed of a chemically inert dielectric material such as quartz. Although not limited by dimension, the reaction tube can have a diameter from about 2 to 4 cm and a length of 5 to 50 cm. Dielectric barrier discharge plasma reactors 204 include a pair of electrodes 222 and 224. FIGS. 2A and 2B depict a variation in which electrode 222 is a central electrode placed within reaction tube 220 and electrode 224 is located on the outside of the reaction tube. In a refinement, electrode 224 is coated on the outside of reaction tube 220. FIGS. 5A and 5B depict a variation in which both electrodes 222 and 224 are located on the outside of reaction tube 220. In a refinement, electrodes 222 and 224 are coated on the outside of reaction tube 220. Power supply 208 provides the AC voltage across the electrodes as described below. In a refinement, power supply 208 is a negative power supply of 5-50 kV with an optional rectifier for plasma generation. Multiple electrodes can be made of conduction metals such as stainless steel and nickel alloys.

In refinement, plasma reactor system 200 includes furnace 212 for heating the plurality 202 of dielectric barrier discharge (DBD) plasma reactors 204ⁱ. The reactors can be heated with clamp-shale furnace power with non-renewable or renewable electric sources. Alternatively, power produced at the site can also be used for heating the furnace. It should be appreciated that each reactor can be plasma generated with heating therein. Furnace can be used alone to generate a plasma or in combination with the dielectric barrier discharge (DBD) plasma reactors 204ⁱ.

In a variation, each DBD plasma reactor 204 is packed with transition metal oxide catalyst. The catalyst can include a transition metal either supported or unsupported. The supports can include one metal oxide or a mixture of metal oxides. In a refinement, supports are oxides of p-block elements of the periodic table or hybrids such as zeolites, hydrotalcites or phosphor-silicates, activated carbon, and carbon nanotubes. In a refinement, the catalyst support includes a component selected from the group consisting of metal oxides, zeolites, hydrotalcites or phosphor-silicates, activated carbon, carbon nanotubes, and combinations thereof. Oxide supports may be acidic, neutral, or basic. Catalyst support with either oxygen storage capability or exhibiting redox property such as CeO₂ can also be used. Different loading of metal and supports weight ratio (0.1-100) can be used for specific applications. In a refinement, the catalysts are promoted with metal promoters or unpromoted.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A methane purification system comprising:
one or more components that cool and compress an input methane-containing gaseous mixture stream to form a first methane-containing gaseous mixture stream;
a filter-separator in fluid communication with the one or more components that receives the first methane-containing gaseous mixture stream removing water therefrom to form a second methane-containing gaseous mixture stream;
an activated carbon station that receives the second methane-containing gaseous mixture stream removing hydrogen sulfide therefrom to form a third methane-containing gaseous mixture stream;
a methanol scrubber that receives the third methane-containing gaseous mixture stream or an expanded stream therefrom, removing carbon dioxide to form a fourth methane-containing gaseous mixture stream; and
a final stage separator that produces a purified methane stream from the fourth methane-containing gaseous mixture stream or an expanded stream therefrom.

2. The methane purification system of claim 1, wherein the final stage separator is an LNG separator.

3. The methane purification system of claim 1, wherein the final stage separator is a PSA/membrane system.

4. The methane purification system of claim 1, wherein the input methane-containing gaseous mixture stream includes methane and one or more of carbon dioxide, nitrogen, oxygen, water, hydrogen sulfide, and methanol.

5. The methane purification system of claim 1, wherein the input methane-containing gaseous mixture stream includes a biogas.

6. The methane purification system of claim 1, wherein the input methane-containing gaseous mixture stream includes greater than 40 mole percent methane.

7. The methane purification system of claim 1, wherein the input methane-containing gaseous mixture stream includes 30 to 60 mole percent carbon dioxide.

8. The methane purification system of claim 1, wherein the filter-separator includes a packed column.

9. The methane purification system of claim 1, wherein the third methane-containing gaseous mixture stream emerging from the activated carbon station flows through expansion valve which drops temperature and pressure prior to being introduced into the methanol scrubber.

10. The methane purification system of claim 9, wherein the fourth methane-containing gaseous mixture stream flows through a turbo-expander which further drops temperature and pressure prior to flowing into a liquified natural gas (LNG) separator.

11. The methane purification system of claim 1, wherein a carbon dioxide and methanol stream flows from the methanol scrubber.

12. The methane purification system of claim 1, wherein a higher alcohols with higher selectivity are produced.

13. The methane purification system of claim 1 further comprising a dielectric barrier discharge reactor configured to produce ethanol from CO₂.

14. The methane purification system of claim 13, wherein the dielectric barrier discharge reactor utilizes a mixed metal oxide catalyst to produce alcohol with a higher selectivity towards ethanol than other alcohols.

15. The methane purification system of claim 13, wherein the higher selectivity towards ethanol varies form 50-100% depending on the input methane-containing gaseous mixture stream and catalyst recipe.

16. A methane purification system comprising:
one or more components that cool and compress an input methane-containing gaseous mixture stream to form a first methane-containing gaseous mixture stream;
a filter-separator in fluid communication with the one or more components that receives the first methane-containing gaseous mixture stream removing water therefrom to form a second methane-containing gaseous mixture stream;
an activated carbon station that receives the second methane-containing gaseous mixture stream removing hydrogen sulfide therefrom to form a third methane-containing gaseous mixture stream;
a methanol scrubber that receives the third methane-containing gaseous mixture stream or an expanded stream therefrom, removing carbon dioxide to form a fourth methane-containing gaseous mixture stream; and
a final stage separator that produces a purified methane stream from the fourth methane-containing gaseous mixture stream or an expanded stream therefrom; and
a dielectric barrier discharge reactor configured to produce ethanol from CO₂.

17. The methane purification system of claim 16, wherein the dielectric barrier discharge reactor utilizes a mixed metal oxide catalyst to produce alcohol with a higher selectivity towards ethanol than other alcohols.

18. The methane purification system of claim 17, wherein the higher selectivity towards ethanol varies form 50-100% depending on the input methane-containing gaseous mixture stream and catalyst recipe.
